(19) United States
(12) Patent Application Publication
(10) Pub. No.: US 2024/0380141 A1
(43) Pub. Date: Nov. 14, 2024

(54) Push-in insert and connector comprising same

(71) Applicant: HARTING Electric Stiftung & Co. KG, Espelkamp (DE)

(72) Inventors: Hongwei YU, Zhuhai (CN); Yingtao WANG, Zhuhai (CN)

(73) Assignee: HARTING Electric Stiftung & Co. KG, Espelkamp (DE)

(21) Appl. No.: 18/656,692

(22) Filed: May 7, 2024

(30) Foreign Application Priority Data
May 9, 2023 (CN) 202310513377.6

(51) Int. Cl. H01R 12/58; H01R 13/428; H01R 13/504

(52) U.S. Cl. CPC H01R 12/585; H01R 13/428; H01R 13/5045

(57) ABSTRACT

A push-in insert for a connector includes a main body, multiple push-in contact assemblies and a retaining plate, and at least one push-in protective grounding assembly arranged on a side wall of the insert, and a protective conductor being connectable onto the protective grounding assembly. A connector includes the push-in insert. Thus, simple, fast, reliable and shock-resistant connections of a protective conducting wire and an electrical conducting wire are achieved, being suited to installation of not only rigid conducting wire but also flexible conducting wire.

### CROSS-REFERENCE TO RELATED APPLICATION

This application claims the benefit of Chinese Patent Application CN 202310513377.6, filed on May 9, 2023, the content of which is incorporated by reference in its entirety.

### TECHNICAL FIELD

The present disclosure relates to a push-in insert for a connector, in particular a mating connector, and to a connector comprising the push-in insert.

### BACKGROUND

The most common wiring method currently on the market is screw wiring, and this type of a method is time-consuming, effortful and gives rise to the problem of screws loosening on transport routes. Therefore, since 2010, a new push-in wiring technology has gradually found application in the field of electrical connections. This technology is simpler, efficient, saves time and effort, and is shock resistant. For example, a contact for a mating member is known from EP3312940B1, the contact comprising a protective grounding element, a contact apparatus being provided on the protective grounding element, the contact apparatus being provided with a housing having two sockets for inserting protective conducting wire, and when the protective conducting wire is inserted, an inflow end of the protective conducting wire with an insulating layer removed pushing a clamping side of a spring element to one side. Therefore, this contact is only suitable for inserting a rigid conducting wire, and this protective grounding element is structurally very complex and not easy to manufacture.

### SUMMARY

The present disclosure provides a push-in insert, the insert having a push-in protective grounding assembly and a push-in contact assembly, which achieves simple, fast, reliable and shock-resistant connections of protective conducting wire and electrical conducting wire, being suited to installation of not only rigid conducting wire but also flexible conducting wire; the protective grounding assembly is structurally simple and has low manufacturing costs.

According to one aspect, a push-in insert for a connector is provided, the insert comprising a main body, multiple push-in contact assemblies and a retaining plate, and at least one push-in protective grounding assembly arranged on a side wall of the insert, and a protective conductor being connectable onto the protective grounding assembly. The protective grounding assembly comprises a protective grounding plate having a housing part, an inverted V shaped spring and a hollow actuator, wherein the spring is partially accommodated in the actuator, and when the actuator is not subjected to a pressing force, the actuator is at a retaining position on the spring and the spring is at a static position relative to the housing part; when the actuator is subjected to a pressing force in a mating direction, the spring can simultaneously perform a pivoting motion and move vertically in the mating direction.

In one embodiment, when the pressing force is released, the spring can simultaneously perform a pivoting motion and move vertically against the mating direction due to elasticity thereof.

In one embodiment, the spring comprises a straight leg and a slanted leg, wherein one side of the actuator is provided with a slope part, and an inner contour of the slope part is constructed to interact with an outer contour of the slanted leg.

In one embodiment, the outer contour of the slanted leg comprises a first step part and a second step part, and when the actuator is not subjected to a pressing force, the slope part is placed on the first step part so that the actuator is in the retaining position; and a protruding piece part of the second step part is engaged on a side wall of the housing part so that the spring is in the static position.

In one embodiment, when the actuator is subjected to a pressing force in the mating direction, movement of the actuator in the mating direction causes the slanted leg to pivot toward the straight leg, with the result that the slanted leg is remote from the side wall of the housing part, so that the protective conductor can be inserted between the slanted leg and the housing part; movement of the actuator in the mating direction further causes the straight leg to move vertically in the mating direction, until stopped by a recess on a side wall of the main body.

In one embodiment, when the pressing force is released, the slanted leg of the spring pivots away from the straight leg, with the result that the protruding piece part of the slanted leg is engaged on the protective conductor that has been inserted, so that the protective conductor is locked between the slanted leg and the side wall of the housing part; at this time, the protective conductor and the housing part side wall are in close contact with each other to realize a protective grounding connection; the straight leg of the spring moves vertically against the mating direction, until a lug arranged on an outer side of the straight leg is stopped by a bottom cut part on another opposite side wall of the housing part.

In one embodiment, the retaining plate is provided, on a narrow side, with an accommodating part, used for accommodating the housing part, the spring and the actuator of the protective grounding assembly, wherein the accommodating part has a socket for accommodating a head part of the actuator and an insertion hole for inserting the protective conductor, wherein a tool applies a pressing force to the actuator through the socket.

In one embodiment, the main body is provided, on a narrow side, with an accommodating part, used for accommodating a contact element of the protective grounding plate, wherein the accommodating part has the recess for stopping the straight leg of the spring.

In one embodiment, the contact assembly comprises a contact housing part, an inverted V shaped spring, an actuator and an electrical contact, wherein the spring is partially accommodated in the actuator, the spring comprises a straight leg and a slanted leg, and movement of the straight leg in the mating direction can be stopped by a first stop part of the bottom of the contact housing part; movement of the straight leg against the mating direction can be stopped by a second stop part of a side face of the contact housing part.

According to another aspect, a connector is provided, the connector comprising the push-in insert and a shell.

By the disclosed design, fast connection of rigid/flexible conducting wire can be achieved with the aid of an ordinary tool (such as a screwdriver). Due to the enduring elasticity of a spring, stable contact of conducting wire for a long time may be ensured, thus providing excellent shock-resistance, and due to the self-locking capability of the spring, the drawing force of the conducting wire is noticeably larger, ensuring a greater contact force between the conducting wire and the housing part of the protective grounding plate. In addition, the overall structure of the protective grounding assembly is simple, convenient for manufacture, thereby reducing production costs. A mating connector comprising the push-in protective grounding assembly and the push-in contact assembly, since simpler and efficient to install, can be used in various industries, including electrical, rail transport, process control, chemical engineering, etc.

### BRIEF DESCRIPTION OF THE DRAWINGS

Embodiments of the present invention are shown in the accompanying drawings and are explained in more detail below.

FIG. 1 is a three-dimensional drawing of a connector;

FIG. 2 is a three-dimensional drawing of inserts mated together;

FIG. 3 is a three-dimensional drawing of a male insert;

FIG. 4 is an exploded view of a male insert;

FIG. 5 is a side view of a male insert, wherein a retaining plate is removed;

FIG. 6 is a three-dimensional view of a female insert;

FIG. 7 is an exploded view of a female insert;

FIG. 8 is a side view of a female insert, wherein a retaining plate is removed;

FIG. 9 is a three-dimensional view of a protective grounding assembly;

FIG. 10 is an exploded view of a protective grounding assembly;

FIG. 11 is an exploded view of a protective grounding assembly from another visual angle;

FIG. 12 is a three-dimensional view of a male contact assembly;

FIG. 13 is a bottom view of a male contact assembly;

FIG. 14 is a three-dimensional view of a female contact assembly; and

FIG. 15 is a bottom view of a female contact assembly.

The accompanying drawings include some simplified schematic drawings. In certain scenarios, the same reference labels are used for elements which may or may not be the same. Different views of the same element may be scaled differently.

### DETAILED DESCRIPTION

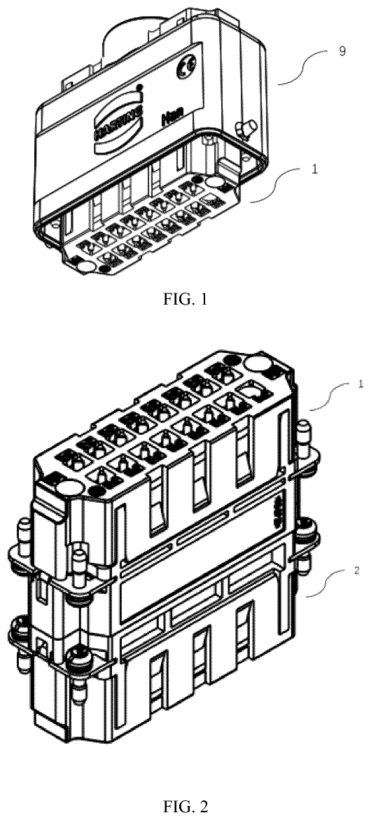

FIG. 1 shows a connector, specifically a three-dimensional drawing of a mating connector. This mating connector has a shell 9, and a push-in insert 1, 2 is accommodated in the shell 9. FIG. 2 shows two push-in inserts 1, 2 (i.e. a male insert 1 and a female insert 2) mated together, which are accommated in the shell 9. The inserts both have a rectangular shape.

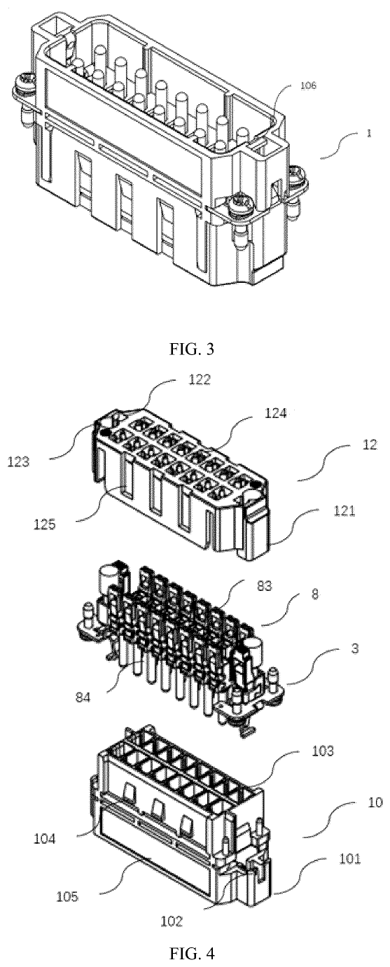

Specific structures of the inserts 1, 2 are now described with reference to FIGS. 3 to 8.

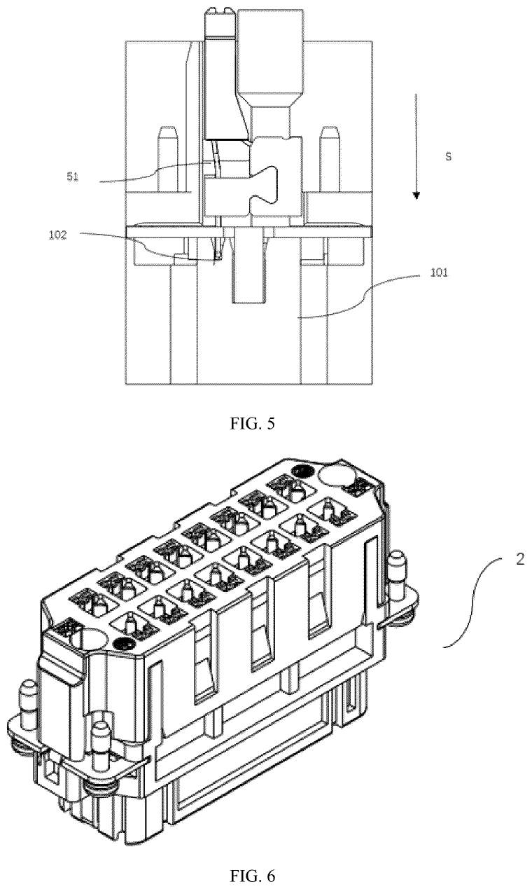

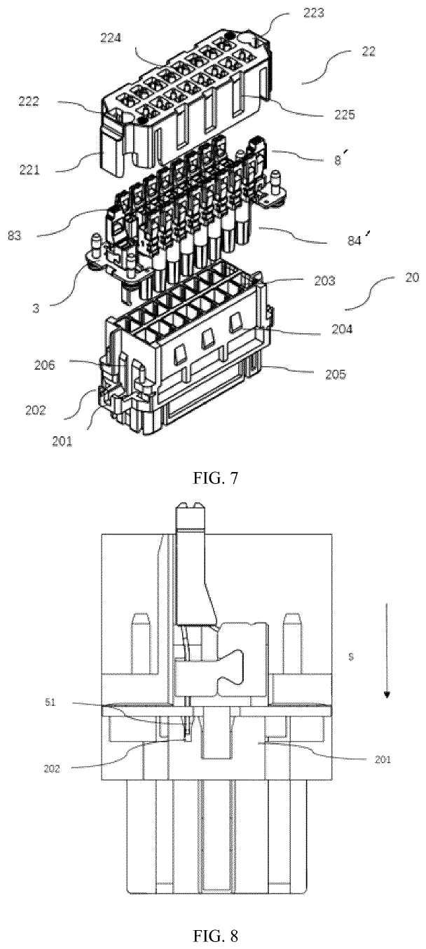

FIGS. 3 and 6 respectively show three-dimensional drawings of the insert 1 and the insert 2, and FIGS. 4 and 7 respectively show exploded views of the inserts 1 and 2. The inserts 1 and 2 respectively comprise main bodies 10, 20 and multiple push-in contact assemblies 8, 8′ (i.e. a push-in male contact assembly 8 and a push-in female contact assembly 8′), the main bodies having multiple sockets 103, 203 to respectively accommodate electrical contacts 84, 84′ (i.e. a male contact 84 and a female contact 84′) of the contact assemblies 8, 8′. The inserts 1, 2 further both comprise retaining plates 12, 22, top faces of the retaining plates having multiple sockets 124, 224 to respectively accommodate actuators 83 of the contact assemblies 8, 8′. During assembly, the retaining plates are locked on the main bodies by means of locking between locking windows 125, 225 on wide sides (i.e. longitudinal sides) of the retaining plates and locking lugs 104, 204 on wide sides of the main bodies, thereby fixing the contact assemblies inside the inserts. Each main body has a mating section 105, 205 which mates with the mating section 205, 105 of the main body of a matching insert in mating direction S (FIG. 5 and FIG. 8).

As shown in FIGS. 4 and 7, the inserts 1, 2 are further provided, on side walls of two narrow sides (i.e. transverse sides), with push-in protective grounding assemblies 3. The protective grounding assembly 3 fixes the insert in the corresponding shell 9 by means of a screw, and also provides protective contact between the male insert and the female insert.

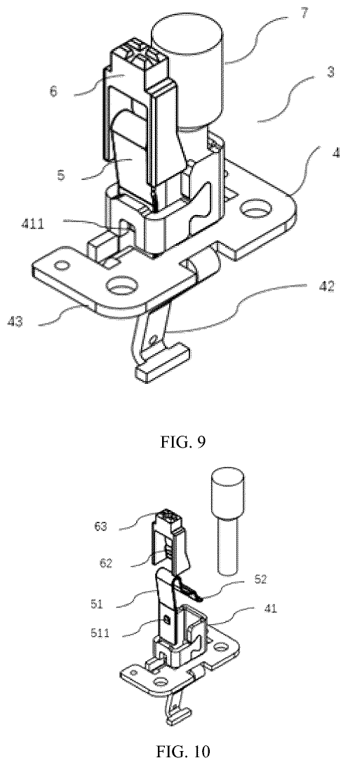

The specific structure of the push-in protective grounding assembly 3 is now described with reference to FIGS. 9 to 11.

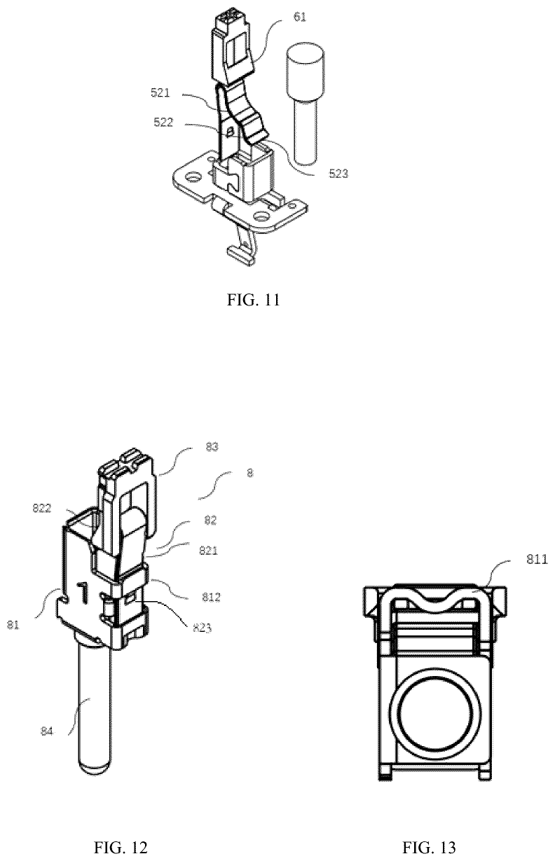

FIG. 9 is a three-dimensional drawing of the protective grounding assembly, and FIGS. 10 and 11 are exploded views of the protective grounding assembly. The protective grounding assembly 3 has a protective grounding plate 4, an inverted V shaped spring 5 and an actuator 6. The protective grounding plate 4 comprises a contact element 42 that extends in the mating direction S and is used for providing electrical contact with a protective grounding assembly of a matching insert, a housing part 41 for accommodating the spring and the actuator, and a flat plate part 43 that extends perpendicularly to the mating direction S and has a screw hole for screw connection to a screw. The protective grounding plate 4 is made of metal, preferably a copper alloy. The inverted V shaped spring 5 comprises a straight leg 51 and a slanted leg. The straight leg is provided, on an outer side face, with a lug 511. An outer contour of the slanted leg comprises a first step part 521 and a second step part 522, wherein the second step part is further from the straight leg than the first step part is. The spring is made of metal, preferably stainless steel, more preferably spring steel, and most preferably high-strength nickel-chromium spring steel. The actuator 6 is a hollow structure, which is provided with a head part 63 for a tool such as a screwdriver to act on, and two side walls 62 extending down from the head part, and a slope part 61 extending between the two side walls (FIG. 11). The two side walls and the slope part jointly form an opening of the hollow actuator.

In an assembled state, the spring is partially accommodated in the actuator. Specifically, the straight leg 51, guided by the two side walls 62, is inserted into the opening of the actuator 6, while the shapes of the outer contour of the slanted leg 52 and the inner contour of the slope part 61 cooperatively interact with each other, until the bottom side of the slope part 61 is placed on the first step part 521 of the slanted leg 52; in other words, due to the second step part protruding from the first step part and the rigidity of the spring, the slope part is stopped by the first step part, such that the actuator is in a retaining position on the spring, the spring cannot further enter into the opening of the actuator, and at this time, the actuator is not subjected to a pressing force from a tool for example. At the same time, in the assembled state, the combined body of the spring 5 and the actuator 6 are accommodated in the housing part 41 of the protective grounding plate 4. A protruding piece part 523 of the second step part 522 of the slanted leg 52 of the spring 5 is engaged on a side wall of one side of the housing part 41, and due to the rigidity and self-locking of the spring, the spring is in a static position. FIG. 8 shows the static position of the spring.

When insertion of a protective conductor 7 (which may be a rigid conducting wire, a multi-stranded rigid conducting wire, or a flexible conducting wire) is desired, firstly the head part of the actuator is pressed with the aid of a tool, and the actuator is subjected to a pressing force in the mating direction S at this time; under the effect of the pressing force, the actuator moves in the mating direction, so as to act on the spring such that the spring simultaneously performs a pivoting motion and a vertical motion. Specifically, the slanted leg 52 is subjected to a pressure of the actuator, so as to pivot towards the straight leg 51 and be away from a side wall of the housing part 41; at the same time, under the pressure of the actuator, the straight leg 51 moves vertically in the mating direction (downwards), and extends out of the housing part 41 through an opening (not shown) of the flat plate part 43 of the protective grounding plate 4, wherein FIGS. 5 and 8 show the state of the straight leg 51 extending out of the flat plate part 43; a gap is thereby formed between the slanted leg and the side wall of the housing part, and thus the protective conductor may be inserted into this gap. As shown in FIGS. 5 and 8, side walls of the main bodies 10, 20 are provided with recesses 102, 202, so as to provide downward stopping for the straight leg 51. After the protective conductor 7 is inserted in the gap, the tool lifts up, that is the pressing force is released. At this time, since the actuator no longer applies force to the spring, the slanted leg 52 pivots away from the straight leg 51 due to an elastic force, such that the protruding piece part 523 of the slanted leg 52 is engaged on the inserted protective conductor 7, thereby locking the protective conductor 7 between the slanted leg 52 and the side wall of the housing part 41, and the protective conductor and the side wall are in close contact with each other, ensuring a protective grounding connection. At the same time, the straight leg 51 moves vertically against the mating direction S (upward), until the lug 511 of the straight leg 51 is stopped by a bottom cut part 411 of a side wall of the housing part 41 (this side wall being opposite the side wall of the housing part 41 in contact with the protective conductor 7), that is, this bottom cut part provides upward stopping for the straight leg 51. In other words, the straight leg can move vertically between this upward stopping and downward stopping.

Now, returning to FIGS. 3 to 8, mounting of the protective grounding assembly 3 on the inserts 1, 2 is described. Accommodating parts 101, 201, used for accommodating the contact element 42 of the protective grounding assembly 3, are provided on side walls on two narrow sides of the main bodies 10, 20 of the inserts 1, 2. As shown in FIG. 3, a slot 106, used for partially engaging the contact element 42 of the protective grounding assembly 3, is provided on a side wall of a narrow side of the main body 10 of the male insert 1. As shown in FIG. 7, a guide slot 206, that is formed from two rib parts and used for partially engaging the contact element 42 of the protective contact assembly 3, is provided on a side wall of a narrow side of the main body 20 of the female insert 2. FIGS. 5 and 8 clearly show that recesses 102, 202, which serve to downwardly stop the straight leg 51, are provided on the accommodating parts 101, 201. Accommodating parts 121, 221, used for accommodating the actuator 6, the spring 5 and the housing part 41 of the protective grounding plate 4 of the protective grounding assembly 3, are provided on side walls of two narrow sides of retaining plates 12, 22 of the inserts 1, 2. The accommodating parts 121, 221 have sockets 122, 222 for accommodating the head part 63 of the actuator 6, and insertion holes 123, 223 for inserting the protective conductor 7. The tool may apply a pressing force to the head part 63 of the actuator 6 from above the retaining plates 12, 22 through the insertion holes 122, 222. As shown in FIGS. 3 and 6, once assembled, the accommodating part of the retaining plate abuts an upper surface of the flat plate part of the protective grounding plate, the accommodating part of the main body abuts a lower surface of the flat plate part of the protective grounding plate, and a screw is screwed into the screw hole of the flat plate part.

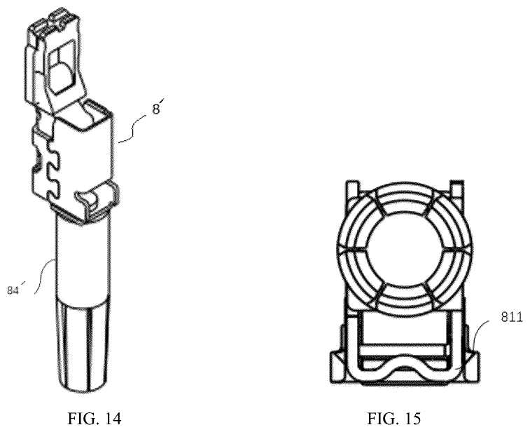

Push-in contact assemblies 8, 8′ are now described with reference to FIGS. 12 to 15. FIGS. 12 and 13 respectively show a three-dimensional drawing and a bottom view of a male contact assembly 8. FIGS. 14 and 15 respectively show a three-dimensional drawing and a bottom view of a female contact assembly 8′. A difference between the male contact assembly 8 and the female contact assembly 8′ lies in electrical contacts, wherein an electrical contact of the male contact assembly 8 is a male contact 84 and an electrical contact of the female contact assembly 8′ is a female contact 84′; therefore, the description is provided taking only the male contact assembly 8 as an example. The contact assembly 8 comprises a contact housing part 81, an inverted V shaped spring 82 and an actuator 83. The spring 82 is partially accommodated in the actuator 83 and comprises a straight leg 821 and a slanted leg 822. Since basically similar in principle to the protective grounding assembly 3, repeated content is not described here again; the main difference between the two lies in that the straight leg 821 does not extend outside the contact housing part 81, rather a first stop part 811 (that is, a bent plate) is arranged on a bottom part of the contact housing part, and a second stop part 812 is arranged on a side face of the contact housing part. When the actuator 83 is subjected to a pressing force, movement of the straight leg 821 in the mating direction S is stopped by the first stop part 811; when the pressing force is released, movement of the straight leg 821 against the mating direction S is stopped by the second stop part 812 with the aid of a lug 823. By means of the above structure, an electrical conducting wire may be inserted into the contact assembly by being pushed in, thereby achieving an electrical connection.

Although various aspects or features of the present invention are shown in the drawings in combinations, those skilled in the art will clearly understand that the combinations shown and discussed are not the only feasible combinations, unless otherwise indicated. In particular, mutually corresponding units or features as a whole may be exchanged in different embodiments.

### KEY TO THE FIGURES

1, 2 Insert
10, 20 Main body
101, 201 Accommodating part
102, 202 Recess
103, 203 Socket
104, 204 Locking lug
105, 205 Mating section
106 Slot
206 Guide slot
12, 22 Retaining plate
121, 221 Accommodating part
122, 222 Socket
123, 223 Insertion hole
124, 224 Socket
125, 225 Locking window
3 Protective grounding assembly
4 Protective grounding plate
41 Housing part
411 Bottom cut part
42 Contact element
43 Flat plate part
5 Spring
51 Straight leg
511 Lug
52 Slanted leg
521 First step part
522 Second step part
523 Protruding piece part
6 Actuator
61 Slope part
62 Side wall
63 Head part
7 Protective conductor
8, 8′ Contact assembly
81 Contact housing part
811 First stop part
812 Second stop part
82 Spring
821 Straight leg
823 Lug
822 Slanted leg
83 Actuator
84, 84′ Electrical contact
9 Shell

What is claimed is:

1. A push-in insert (1, 2) for a connector, the push-in insert (1, 2) comprising:
a main body (10; 20),
a push-in contact assembly (8; 8′);
a retaining plate (12; 22);
a protective grounding assembly (3) arranged on a side wall of the push-in insert; and
a protective conductor (7) being connectable onto the protective grounding assembly (3),
wherein the protective grounding assembly (3) comprises
a protective grounding plate (4) having a housing part (41),
a spring (5) having an inverted V shape, and
a hollow actuator (6), and
wherein the spring is partially accommodated in the hollow actuator, and
when the hollow actuator is not subjected to a pressing force, the hollow actuator is at a retaining position on the spring and the spring is at a static position relative to the housing part, and
when the hollow actuator is subjected to a pressing force in a mating direction(S), the spring can simultaneously perform a pivoting motion and move vertically in the mating direction.

2. The push-in insert (1, 2) according to claim 1,
wherein when the pressing force is released, the spring can simultaneously perform a pivoting motion and move vertically against the mating direction due to elasticity thereof.

3. The push-in insert (1, 2) according to claim 2,
wherein the spring (5) comprises a straight leg (51) and a slanted leg (52),
wherein one side of the hollow actuator (6) is provided with a slope part (61), and
wherein an inner contour of the slope part is constructed to interact with an outer contour of the slanted leg.

4. The push-in insert (1, 2) according to claim 3,
wherein the outer contour of the slanted leg (52) comprises a first step part (521) and a second step part (522), and
wherein, when the hollow actuator is not subjected to a pressing force, the slope part (61) is placed on the first step part (521) so that the hollow actuator is in the retaining position; and a protruding piece part (523) of the second step part (522) is engaged on a side wall of the housing part (41) so that the spring is in the static position.

5. The push-in insert (1, 2) according to claim 4,
wherein, when the hollow actuator is subjected to a pressing force in the mating direction, movement of the hollow actuator in the mating direction causes the slanted leg (52) to pivot toward the straight leg (51), whereby the slanted leg is remote from the side wall of the housing part (41), so that the protective conductor (7) can be inserted between the slanted leg and the housing part; and movement of the hollow actuator in the mating direction further causes the straight leg (51) to move vertically in the mating direction, until stopped by a recess (102, 202) on a side wall of the main body (10; 20).

6. The push-in insert (1, 2) according to claim 5,
wherein, when the pressing force is released,
the slanted leg (52) of the spring (5) pivots away from the straight leg (51), whereby the protruding piece part (523) of the slanted leg is engaged on the protective conductor (7) that has been inserted, so that the protective conductor is locked between the slanted leg and the side wall of the housing part (41), and
the straight leg (51) of the spring (5) moves vertically against the mating direction, until a lug (511) arranged on an outer side of the straight leg (51) is stopped by a bottom cut part (411) on another opposite side wall of the housing part (41).

7. The push-in insert (1, 2) according to claim 1,
wherein the retaining plate (12; 22) is provided, on a narrow side, with an accommodating part (121; 221), for accommodating the housing part (41), the spring (5), and the hollow actuator (6) of the protective grounding assembly (3),
wherein the accommodating part (121; 221) has a socket (122; 222) for accommodating a head part (63) of the hollow actuator (6) and an insertion hole (123; 223) for inserting the protective conductor (7), and
wherein a tool applies a pressing force to the hollow actuator (6) through the socket (122; 222).

8. The push-in insert (1, 2) according to claim 5,
wherein the main body (10; 20) is provided, on a narrow side, with an accommodating part (101; 201), used for accommodating a contact element (42) of the protective grounding plate (4), and
wherein the accommodating part (101; 201) has the recess (102, 202) for stopping the straight leg (51) of the spring (5).

9. The push-in insert (1, 2) according to claim 1,
wherein the push-in contact assembly (8, 8′) comprises a contact housing part (81), an inverted V shaped spring (82), an actuator (83), and an electrical contact (84, 84′),
wherein the spring is partially accommodated in the actuator,
wherein the spring comprises a straight leg (821) and a slanted leg (822),
wherein movement of the straight leg in the mating direction(S) can be stopped by a first stop part (811) of a bottom of the contact housing part, and
wherein movement of the straight leg against the mating direction can be stopped by a second stop part (812) of a side face of the contact housing part.

10. A connector, comprising
the push-in insert (1, 2) according to claim 1, and
a shell (9).
